(19) United States
(12) Patent Application Publication
(10) Pub. No.: US 2013/0054750 A1
(43) Pub. Date: Feb. 28, 2013

(54) SYSTEM AND METHOD FOR REQUESTING MEDIA COVERAGE OF AN EVENT

(71) Applicant: Alain Rossmann, Palo Alto, CA (US)

(72) Inventor: Alain Rossmann, Palo Alto, CA (US)

(73) Assignee: VLOGNOW, INC., Palo Alto, CA (US)

(21) Appl. No.: 13/215,512

(22) Filed: Aug. 23, 2011

(51) Int. Cl. G06F 15/16

(52) U.S. Cl. 709/219

(57) ABSTRACT

An internet server based computerized system and method to request media coverage of an event from smartphone (or other wireless computerized device) carrying potential event participants who are near the event's space-time location. Here event media requestors post event space-time location and media data requests on the invention's internet server database, and at various time intervals, this server in turn polls (by either a push or pull process) the position of the various potential event participants who are running the invention's application software on their smartphones. If the internet server determines that there is a match, the server transmits the event media request to the relevant potential event participants, along with additional information such as the number of requestors. Potential event participants can thus acquire the event media data, and upload or stream this media data back to the internet server, which can notify requestors when the data is available.

### BACKGROUND OF THE INVENTION

1. Field of the Invention

This invention is in the field of electronic media and mobile communications devices and methods.

2. Description of the Related Art

As internet technology, wireless communications technology, and high-resolution video camera equipped smartphones have proliferated, technology has advanced to the point where it is common for individuals to routinely carry sophisticated video recording and transmission equipment wherever they go. Indeed, major news networks, such as Cable News Network (CNN), now make extensive use of “iReports”, where individual volunteer reporters send in smartphone derived video. Today the initial coverage of many natural disasters and other unscheduled events often comes from such amateur smartphone video.

To obtain such volunteer supplied video, CNN's internet servers generate an assignment desk webpage that lists topics of present interest to the CNN editors. As an example, the CNN assignment desk webpage for Aug. 11, 2011 requests reports for the London riots, Stock market investments, 9/11 anniversary stories, a heat wave and drought in the US, and other severe weather stories. Thus a CNN viewer interested in potentially contributing media coverage of an event to CNN can look up this assignment desk web page on their computerized handheld device (e.g. smartphone, tablet computer, and the like), scroll down to the current listed stories of interest, and if the potential volunteer happens to have media material on one of the listed areas of interest, they can then upload it to the CNN iReport site.

Similarly various social media websites, such as Twitter, have also become another way of acquiring media coverage of events. A notorious example of such social media coverage occurred during the 2011 US military raid on Osama Bin Laden's enclave. During this raid, a Pakistani Twitter user, writing under the name of @ ReallyVirtual, posted live twitter feeds complaining about unexpected helicopter noise in the Abbottabad region at 1 AM in the morning. This initial posting was subsequently followed, in the following days, by @ReallyVirtual's photographs of the cleared Abbotabad streets in his Twitpic account. Thus using Twitter, another Twitter user that @ReallyVirtual was following could have contacted @ReallyVirtual via Twitter and requested additional photographs of Abbotabad. Given how notorious this event was, most likely a number of Twitter users actually did so.

However in other situations, for example when a student knows that he or she will miss the first day of class, or a parent knows that he or she will miss their child's sports game, unless that individual desiring media coverage of such everyday events knows someone in advance who is attending the event and who might respond favorably to a request to make a recording of the event, that person is out of luck. There are no easy ways to do this at present.

### BRIEF SUMMARY OF THE INVENTION

The problem with prior art methods of soliciting and requiring media coverage of a particular event, exemplified by the iReport and Twitter examples above, is that for many uses, such methods tend to be both cumbersome and inadequate. The CNN iReport web page request format may be adequate for a famous worldwide news organization, which likely may have hundreds of thousands of eager would-be reporters or potential event participants, but it requires that the potential event participant check in to the CNN iReport web page frequently and scan it to find if he or she is near a potential event of interest to the CNN editors. This approach is unfeasible lower profile individuals or organizations, who may merely want to get media coverage of less notorious events.

Similarly existing social network based methods of soliciting media, such as Twitter, also are far from ideal in this regard. Here an event media requestor will not get media coverage of an event unless: 1) a member of the media requestor's social network is attending an event; 2) the media requestor suspects this is the case and posts an advance request for event media coverage on the social network; 3) another existing member of the media requestor's social network happens to read this media request before or at the time of attending the event; and 4) this potential event attendee subsequently decides to grant the request. This doesn't happen very often.

Thus the invention is based, in part, on the insight that at present, individuals (e.g. anyone who is not a major news organization) who are interested in obtaining digital media (e.g. sound, images, video) related to any kind of event they cannot attend, from small scale personal events to large scale public events, and who are unaware of any friends or acquaintances attending this event, have no easy way to express this interest to presently unknown individuals who may be planning to attend the event. Similarly those individuals who are attending an event, who might otherwise be disposed to grant such a request for media coverage, have no easy way of determining who else might be interested in getting such event media coverage.

Put alternatively, event media requestors presently have no easy way to express, to other presently unknown potential event attendees, the requestor's interest in getting access to digital media related to the event. Similarly potential event attendees have no easy way of knowing if there are other, presently unknown individuals, who might want media coverage of what otherwise might be a routine and unremarkable event.

The invention is thus intended to fill an unmet need for a system and method to link individuals who may not be able to attend an event, but who are interested in digital media recordings or other data from that event, to other individuals who are planning to attend that event. The present invention accomplishes this goal by providing a computerized internet server based system and method wherein users interested in specific events can declare an interest in the events through registering a “want event media” notice on an internet server database. The server can automatically keep track of the event location and time, as well as the various locations over time of the mobile computerized devices (e.g. smartphones) carried by other individuals who, by loading the invention's application software (apps) on their own devices, and activating the application software, have indicated to the internet server that they may be willing to grant a request for event media if they end up attending an event (with a location and time) of interest.

Thus using the invention, event attendees, or potential event attendees who are either attending the event or are planning on attending the event, can be notified of such a “want media notice” (i.e. event media request) in real-time, often via their wireless and internet connected smartphones, either shortly before the event starts of interest, or at the event of interest. Indeed, if multiple media requestors request event media for this event, the media request count (number of such event media requestors for this event) may also be communicated by the invention. Thus a potential event attendee, knowing in advance by the count number that a high number of individuals desire coverage of that event, may be more inclined to cooperate. The system can also reward cooperative individuals by giving a positive feedback score, and/or by giving positive feedback to the individual's other online social networks of choice.

In some embodiments, the invention may also provide a convenient depository or online library for such event media. Here, for example, event attendees who end up cooperating with the request for event media may in turn stream or upload event media, such as audio, image, or video data from the event to the system's online internet server(s). The system may in turn notify the various event requestors that the requested event media data is now available The system may also make this media available to other requestors as well, such as requestors who may not have originally expressed interest in the event, but who may later wish to retrieve the event media data.

In other embodiments, the system and method may allow media requestors to simply browse a catalog of event media at their leisure, and download selected event media data as needed.

In still other embodiments, the system may simply post notices that the event media data is available from various event attendees, and then provide peer-to-peer network links or other network link mechanisms by which an event media requestor can download media data directly from devices controlled by the event attendees. In this later embodiment, the system operators will not actually store the event media on their system database, but rather simply serve as a way to facilitate event media exchange.

### BRIEF DESCRIPTION OF THE DRAWINGS

FIG. 1 shows an overview of the invention's internet server and mobile computerized device based system and method for requesting media coverage of an event.

FIG. 2 shows more detail on how various requestors can request media coverage of an event.

FIG. 3 shows more detail of a method by which the invention's server can provide media requests for a specific event to a mobile computerized device carried by a proper potential event attendee.

FIG. 4 shows more detail of a method by which a potential event attendee, having decided to attend the event and grant the request for event media, may then produce the event media data and make the event media data available to the various event media requestors.

FIG. 5 shows more detail of one method by which various requestors can obtain media data pertaining to an event.

### DETAILED DESCRIPTION OF THE INVENTION

In one embodiment, the invention may be an internet server (and associated database) method of requesting and receiving media coverage of an event. This internet server method will in turn usually interact with a plurality of different mobile computerized devices. These mobile computerized devices are typically handheld devices with display screens, microprocessor(s), at least one wireless transceiver (e.g. a WiFi transceiver, Cell phone transceiver) usually a Global Positioning System receiver, at least one video camera, and at least one microphone. Such mobile computerized devices may, for example be smartphones (exemplified by the popular Apple iPhone or Android series of smartphones), but may also be other types of devices such as tablet devices (e.g. Apple iPad-like devices), notebook computers, or equivalent.

These mobile computerized devices are assumed to be capable of establishing a bidirectional data connection with the internet, often through various wireless methods, such as local WiFi links, cellular telephone links to cellular telephone towers, and the like.

The invention's internet server and associated database will typically be implemented by one and often a plurality of standard internet servers, data storage devices (e.g. hard drives, solid state data storage devices), usually running under the control of one or more processors (often of the popular x86 series, ARM series, MIPs series, PowerPC series, and the like). These servers will typically be running under the control of various operating systems, such as Linux, Unix, Windows, iOS, and the like, and will in turn often be running various web server programs (e.g. Apache, Microsoft IIS, nginx, Google GWS, and the like), various database programs (e.g. MySQL) and the like. In particular, the methods of the present invention will often be implemented in the form of various types of software programs and scripts running on the various servers, and also will be implemented in the form of various application software programs (Apps) running on the various user's mobile computerized devices. Thus generally the invention's methods are implemented by a combination of server/database software, and mobile computerized device software, acting together to create the complete system.

In one embodiment, the invention may be a system and method by which a requestor (e.g. someone who may not themselves intend to attend an event, but who nonetheless wants media coverage of the event) may request media data pertaining to an event. Typically each event may have its own unique name/identification, which may consist of an event common name (e.g. “Math 100 Class, or Concert in Town Park), as well as a usually unique identifier such as a unique event serial number, which can be automatically generated by the invention's system software. The event will also typically have an event spatial location, which may be specified by various alternate means, including latitude, longitude and optionally height (e.g. for a multi-story building), or by standard street addresses, building names, and room names/numbers, or by whatever alternate position determination method is convenient. Generally the invention's system software will be configured as to convert back and forth between such alternate spatial location methods, in some cases with the assistance of third party mapping software such as Google maps and the like.

Each event will also generally have its own specific time, which may either be specified as a combination of time zone, time adjustments (e.g. daylight savings time or not), date, and time, or alternatively may be internally converted to a single standard such as Greenwich mean time (GMT), or Coordinated Universal Time (UTC) and then converted to the various user's local times as appropriate.

Although each event may often have a plurality of attendees, before the event starts, it is not 100% certain that any individual intending to attend an event will actually do so. Since the invention will generally be more useful if the event attendee receives the media request at least a few minutes before the event starts, and since the system can't tell the future, here all individuals that may, by virtue of their being close to the event spatial location at a time close to the event time, will be considered by the system to be potential event attendees. This nomenclature will apply even if the potential event attendees, explicitly check into the server and confirm that they intend to attend the event. Further, to avoid confusing changes in nomenclature, this term “potential event attendees” will be used to designate those individuals who subsequently do attend the event and grant the request for event media data.

At a higher level of abstraction, the invention's method and system functions by first determining the event name or event ID, event time and event spatial location; and then posting at least the event time and event spatial location of on an Internet server (and often the event name or event ID as well), along with a request for at least one type of media data from said event. This “determination” of the event parameters may either be done by various requestors who input this information, or alternatively a pre-populated event list containing these various event parameters may be automatically or semi-automatically generated by the internet server software, and the event media data requestors can select from this pre-populated event list.

The potential event attendees who are within a predetermined time window and spatial location proximate the event may then instruct the invention's applications software onboard their mobile computerized devices (e.g. smartphones) to access this internet server, often on an automatic or semi-automatic basis. This accessing can be on a “pull” basis—for example an application running on the user's smartphone can, either automatically (e.g. every 15 minutes) or upon user request make contact with the internet server, transmit the user's present location, and determine if there are any event media requests relevant to the user's particular space and time coordinates. Alternatively, in a “push” basis, the internet server software can initiate contact with the appropriate software application running on the potential event attendee's mobile computerized device, request the potential event attendee's present location, perform the relevant database lookup calculations, and transmit the appropriate event media requests to the potential event attendee.

The criteria by which the invention's internet server, associated database, and software, determines if the mobile computerized device carried by a potential event attendee is within a close enough predetermined time window and spatial location window proximate any given event can vary, and indeed can even be adjustable. Generally, to avoid too many false positives, it may be useful to have the default predetermined time window and spatial location window be relatively tight, such as a time window that is only a few minutes (e.g. 5 to 30 minutes) away from the start time of an event, and a spatial window that may only be a few feet, such as 50 feet, away from the spatial location of a given event. However in some embodiments, the extent of this time and space window may be adjusted by the potential event attendee, the system operator, or potentially even the event organizer. Thus, for example, a student who runs a lecture recording service as a part-time business, and who routinely attends various classes at a university, might set larger time and space windows in order to have a longer time and space window in which to receive notice that a particular event, such as a lecture, has event media requestors. By contrast, an executive in a downtown high-rise surrounded by other companies' meeting rooms on all levels may wish to set very narrow time and space windows in order to avoid being bombarded by too many irrelevant event media requests.

Once the potential event attendee actually decides to attend that event, receives the event media request and decides to grant the request (either implicitly by going ahead and recording the event, or explicitly by first reporting back that he or she will grant the request, and then recording the event), then the potential event attendee (who is now an actual event attendee, but to avoid confusion, the name will remain the same) will typically use his or her mobile computerized device to also acquire the event media data. This media data may be of various types. Although often the media data will be simply audio recordings of the event, video (i.e. audio and video) recordings of the event, or one or more still images of the event, in principle other event media data may also be obtained. For example, the event handouts, presentations (i.e. slide shows/video, lecture notes, and the like) can also be obtained by the potential event attendee and this also will be considered media data from the event. Thus an event media requestor might ask for a digital copy of the hand-outs from a lecture, and the like.

In other embodiments, the potential event attendee may just record the event media, and then post it to the system event database. Here for example the system may provide a list of events linked close to the place and time where the potential event attendee recorded data, and the potential event attendee may later search the database for the event, and then upload media to the system event database.

In still other embodiments, the potential event attendee, having initially recorded the event on his or her initiative, may receive a media request notification during the event, towards the end of the event, or even after the event. Alternatively the potential event attendee may also on his or her own initiative decide to make the event media data available to media requestors in advance of receiving any request. In these situations, the potential event attendee can then decide to make this already recorded event media data available to the media requestors. This process can be facilitated if the potential event attendee's mobile computerized device (e.g. smartphone) annotates the event media that it records with location and time data. Here then, the invention application software running on the user's device can determine what to select based on this location and time annotation data. In these situations, the potential event attendee can make event media data available on a per recording file basis. Alternatively, event media selected to be made available can be done on a per media data location and time basis. In this situation, the user might to decide to make all media data originally recorded within a given event location and time window available to media requestors.

Once this media data has been obtained by the potential event attendee, then the invention's application software, again running on the user's mobile computerized device, can then stream or upload this event media data to the requestor. This media data transfer can be done by various methods. In a centralized media server approach, the invention's internet server and associated database can be used to store the event media data, and also provide the media data to the requestor. Alternatively the media data transfer or can be done without using a centralized server, such as by one or more peer-to-peer networks such as Gnutella, Skype, or other internet based peer-to-peer network.

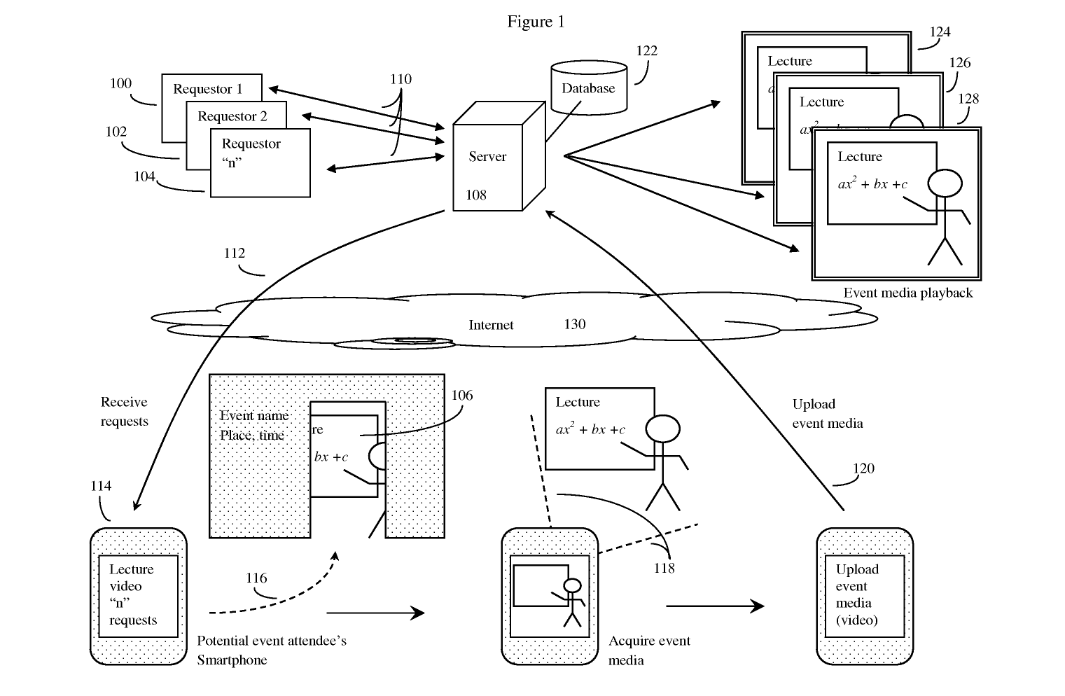

FIG. 1 shows an overview of the invention's system and method for requesting media coverage of an event. Here various event media requestors (100, 102, 104) knowing of an event (106) (here a lecture in location “Classroom” at time “9:00 AM”), can interact (e.g. establish an internet linkage with) with the system's internet server (108) and associated database (122) and post their interest in and request for media coverage of this event. The system's server (108), operating on either a push or pull basis, then transmits (112) this media request information to a mobile computerized device (e.g. a smartphone) (114) operated by at least one potential event attendee who is within a certain space and time window proximate the event of interest.

Assuming that the potential event attendee decides to attend the event (116) (here a math lecture on the quadratic equation) and grant the request (i.e. acquire media data, such as video coverage of the event) (118), the potential event attendee (now an actual event attendee) can then make this event media data available by (for example) uploading (120) this event media data to the server (108) and/or a database associated with the server (122). This server (108) and database (122) can in turn can make copies (124, 126, and 128) of the event media data available to various requestors. Here the internet connection between the server(s) (108) and the mobile computerized device(s) (114) is shown by cloud (130), but the internet cloud between requestors (100, 102, and 104) and server (108) is not shown to avoid unduly cluttering the diagram.

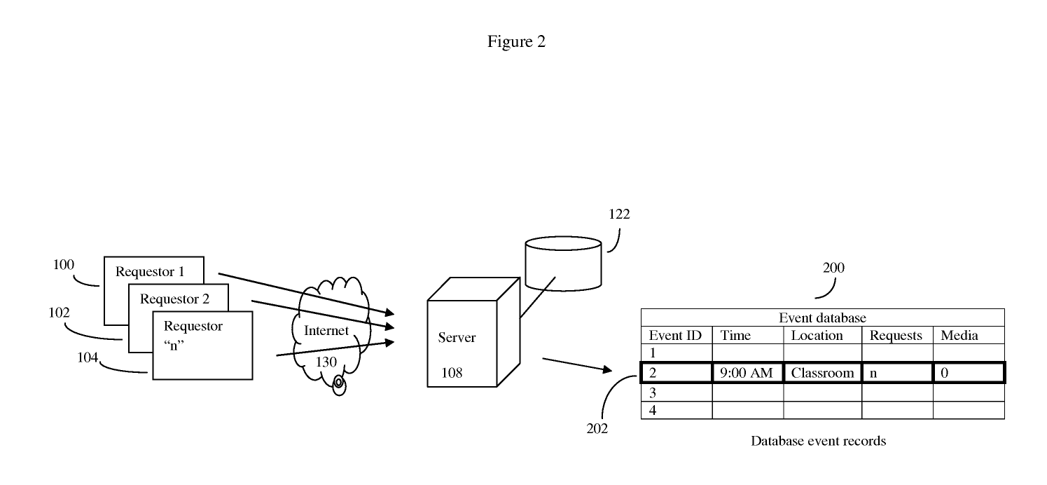

FIG. 2 shows more detail on how various event media requestors can request media coverage of an event. Here these various requestors (100, 102, and 104) may access the invention's internet server (108) over the internet (130), and in one embodiment may post information pertaining to the event, such as the event time, location, and name or identification code (which can alternatively be automatically assigned by the system as needed). This event information can be stored in the various database event records in the event database (200), which is generally stored in the server's database (122) or other database accessible by the server (108). In alternative embodiments, often the server/database (108/122) may provide a pre-populated event list, thus making it easier for the event requestors to enter in the event name, time, and spatial location. In some embodiments, the spatial location of the event may be specified using standard latitude and longitude (and often altitude for multi-story buildings) coordinates. However for ease of use, often the system may accept position information in terms of more commonly used terms such as street addresses, building names and room numbers, and the like, and automatically determine the precise geographic coordinates accordingly. In this example, for brevity, the time coordinate for this particular math lecture event (106), which will normally be expressed in terms of a time zone, time, and date value, is expressed as simply “9:00 AM”, and the spatial location information, which again normally will be expressed as some form of specific location coordinates, here is simply referred to as “Classroom”. Thus the database entry for this example's math lecture event (106) can be seen as record (202) (the darker row in event database 200), and this particular lecture event has been assigned ID number “2” by the system.

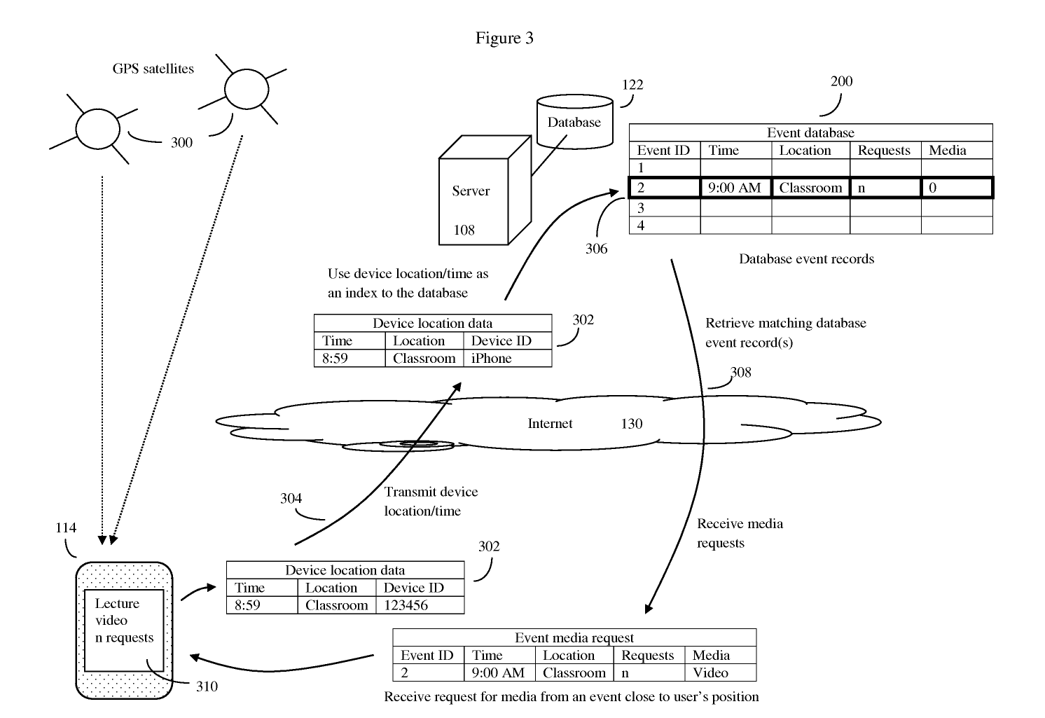

FIG. 3 shows more detail of one of the methods by which the invention's server (108) can transmit media requests for a specific event to the proper potential event attendee, who will typically be carrying a mobile computerized device such as a smartphone (114) or equivalent handheld computerized device. Often the spatial location (position) of the potential event attendee can be determined using Global Positioning Signal (GPS) receivers onboard the potential event attendee's mobile computerized device (114), which in turn captures GPS radio signals from appropriate GPS satellites (300). Alternatively, other location determination methods, such as determining the origin of the wireless signal form the potential event attendee's mobile computerized device, or analysis of images from the mobile computerized device, or direct entry of location, and the like, can also be done.

Once the potential event attendee's spatial location at a particular time is determined, this information (302) and usually a form of mobile computerized device identification (e.g. an ID code or URL identifying the mobile computerized device) is transmitted (304) over the internet (130) to the invention's server (108). There the potential event attendee's location and time is used as a database search index or search parameter to retrieve the various database event records (200) previously discussed in FIG. 2. Appropriate event records (306, 202) matching the database index criteria (e.g. time within 5 minutes of event time, spatial location within 50 feet of the event spatial location) are retrieved by the server/database (108/122) and are transmitted (308) back to the user's mobile computerized device (114). There, software onboard the mobile computerized device (114) can inform the potential event attendee that media data for an event that the potential event attendee may be about to attend, or is attending has been requested (310). Often the system will also inform the potential event attendee about the number of requestors who are requesting media coverage, and additionally the type of media coverage requested. In these examples, it is assumed that the most frequent media coverage requested will be audio-video (e.g. video) coverage of the event. In some embodiments, even more specific coverage requests (e.g. “please photograph my son who is playing the game in uniform #18)” can also be transmitted by the system as desired.

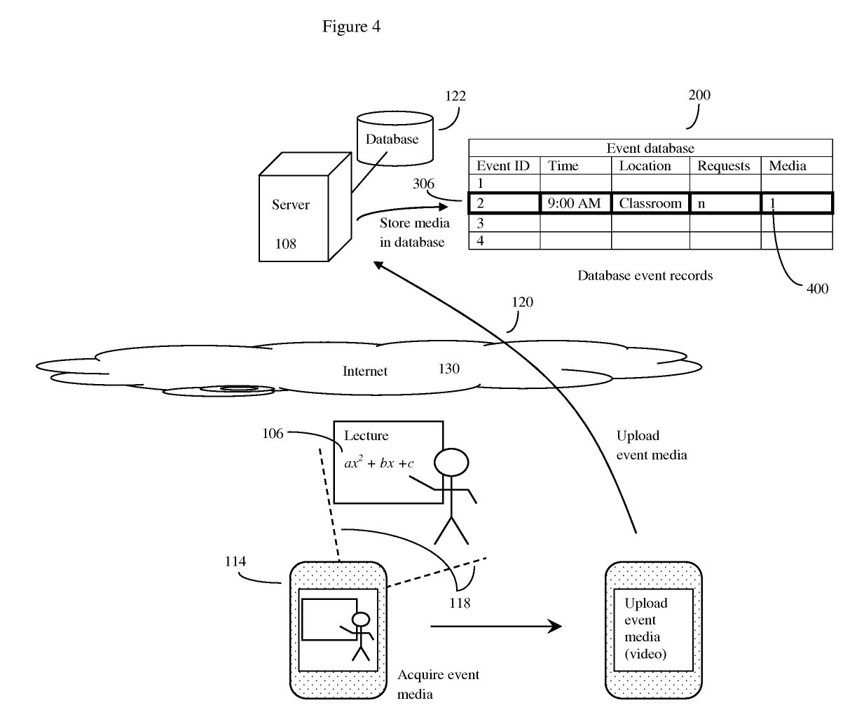

FIG. 4 shows more detail of the method by which a potential event attendee, having decided to attend the event and grant the request for event media, may then produce the media and make the media available to the various event media requestors. Here the potential event attendee (who will again retain the same name to avoid confusion) in this example records video (118) of the event (106) (again using the math lecture example) using his or her mobile computerized device's built-in video camera and microphone. Either during the event (i.e. by streaming) or often after the event (by upload) the invention's software will often then automatically or semi-automatically transmit (120) the event media data (in this example a digital video file of the math lecture) back to the invention's internet server/database (108/122), again over the internet (130), often with at least one intermediate a wireless link such as a WiFi link or a cellular telephone link. Once it is received by server (108) and database (122), the media data, which will often be in the form of one or more digital files, can be stored in the event database, for example under the event record as a media data field, object, or file (400). If multiple potential event attendees decide to do this, then often multiple media files for the same event may be stored in the server's database (400), and any or all of this event media data may potentially be made available to the various event media requestors (100, 102, 104) and optionally other requestors as well. Alternatively, as previously discussed, the event media data may be transmitted to the various requestors by an alternate method, such as a peer-to-peer (P2P) method, that does not store the event media data on a centralized server/database (108/122).

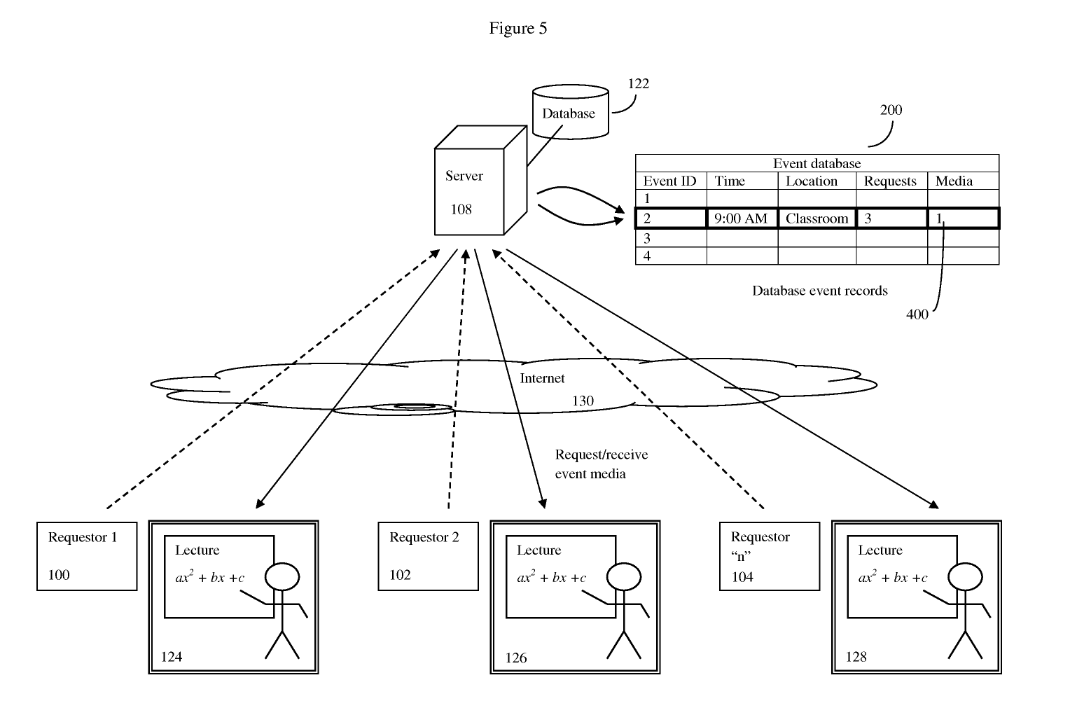

FIG. 5 shows additional details of one method by which various requestors (100, 102, 104) can obtain media data (120), (400) pertaining to an event (106). After one or more potential event attendees have granted the request for event media data and uploaded the event media data (120), (400) to the invention's server and database (108/122), and after this event media data has in turn been properly indexed in the event database (200), (306) by event identification (e.g. event name, identification number) and/or event time and place, then in one embodiment, the server (108) can then notify the various requestors (100, 102, 104) that event media data (120), (400) is now available for use. The various requestors can now stream or download the event media data as desired (124, 126, and 128) from server (108) and database (122). In some embodiments, this event media data (120), (400) can then be persistently stored on the server/database (108/122) for the use of future requestors as well.

Alternatively, and particularly for those events that may be subject to copyright, access to the event media data may be subjected to various restrictions as determined by negotiation between the holder of the event copyright and the operator of the invention's server, the event media requestor, or the potential event attendee.

More specifically, but along the same general theme, the invention may be a computer implemented system and method by which one or more requestors (100, 102, 104) may request media data pertaining one or more events, each event again having an event name or ID, an event time, an event spatial location, and at least one potential event attendee, as discussed previously. As before, the method will comprise determining the event time and event spatial location of the particular event of interest, and posting (110) the event time and event spatial location on an Internet server, (108, 122) and usually the event name or ID as well, along with a request for at least one type of media data from this event.

In this more specific implementation, again as discussed previously, the various potential event attendees are assumed to be carrying mobile computerized devices such as smartphones (114) (e.g. iPhones, Android smartphones and the like). More specifically, but again as previously discussed, such mobile computerized devices are defined as typically comprising a handheld computerized device with a display screen, processor, at least one wireless transceiver (e.g. WiFi transceiver, Cellular telephone transceiver), often at least one video camera, and at least one microphone, and often location sensing mechanisms such as Global Positioning System (GPS) receivers.

Any given potential event attendee may or may not be within a predetermined time window and spatial location window proximate the event time and event spatial location of the event of interest (106). To determine if the potential event attendee is likely to attend the event, and thus is a suitable candidate to receive the event media request, software running on board the internet server (108) and onboard the various mobile computerized devices (114) can direct the server and mobile computerized devices to periodically check on the spatial location of the various potential event attendees and compare their relative spatial locations with a list or database of events (200) (with defined times and spatial locations) with media data requests onboard the internet server.

More specifically, the software onboard the internet server, over a plurality of comparison times, may perform the steps of establishing a bidirectional communications link between the internet server, and applications software running onboard the particular potential attendee's mobile computerized device, and then often automatically:

1: Use the GPS (300) or wireless signal origination data on the mobile computerized device to determine the spatial location of the potential event attendee (302).

2: Transmit the spatial location of the potential event attendee to the Internet server (304).

3: At the internet server (108) and again typically over a plurality of times, compare the spatial location of the potential event attendee with the spatial location of a given event of interest (306).

Software onboard the internet server can determine if the spatial location of the potential event attendee is within a predetermined spatial location window proximate the spatial location of the event; and also determine if the time of the comparison is within a predetermined time window proximate the time of the event (306). Assuming a match, then software onboard the internet server (108) can then automatically direct the internet server to transmit (308) at least the event name or event time and location, as well as the request for at least one type of media data from the event, to applications software running on board the potential event attendee's mobile computerized device (114). As previously discussed, this can be done by either a push or pull process.

Thus if a potential event attendee is near the place (spatial location) and time of an event where media has been requested, his or her mobile computerized device will often provide a visual (310) and or audio indication that media data has been requested. This could be a silent screen message (310), or a small sound or vibration, or both. Often this message will provide the event name, time, location, how many requestors have requested media, and optionally may also provide additional information as to what type of media data is provided (audio, video, images, etc) and other more specialized messages as desired.

If the potential event attendee either decides not to attend the event, or to ignore or decline the request for event media data, then often nothing further will happen. However if the potential event attendee decides to attend the event and grant this request for at least one type of media data from the event, then in some embodiments, the invention may further proceed as follows.

The potential event attendee will obtain (118) at least one type of audio or video media data from the event, often using his or her mobile computerized device (114). Often this media data can be obtained by using the mobile computerized device's standard microphones, cameras. Here the invention's mobile computerized device application software does not necessarily have to handle the burden of actually running the onboard cameras, microphones and the like. Rater in some embodiments, the invention's application software may instead make use of standard audio and video recording utility software for the actual event media data acquisition process. Assuming that more standard audio and video recording software is used, then the invention's applications software may be configured to simply retrieve the media data files produced using such standard audio and video recording or other utility software, and use these media data files for various subsequent steps in the invention.

The potential event attendee may begin the process of transmitting (120) the requested media data to the requestor(s) by either initiating an uploading operation, or at least permitting invention's application software running onboard the potential event attendee's mobile computerized device (114) to transmit the media data. This can be done by various means. In one method, the applications software onboard the mobile computerized device will transmit the event media data (120) to the various requestors using the internet server/database (108, 122) as a centralized media storage device. Thus the media data may be streamed or uploaded to the internet server/database where it may be stored in an appropriately indexed form (400). The internet server may in turn may either automatically notify the various requestors (100, 102, 104) that the requested event media data (400) is now available, and the requestors may in turn download it from the server. Alternatively, as previously discussed, the internet server may act only as a notification and “matchmaking” device, but not actually store the media data files. Rather the media data files may be transmitted to the various recipients by alternate means, such as the previously discussed P2P methods.

### Social Media and Social Network Aspects of the Invention

Although in some embodiments of the invention, the system can operate on a fee (paid) basis in which event requestors pay for the ability to access the requested media, other incentive methods may be used, and indeed in some embodiments, other incentive methods may be preferable.

In one alternate type of incentive scheme, social media and social currency type incentive schemes may be used. Here for example, potential event attendees can be motivated to respond for event media requests by getting feedback from the system as to the numbers of potential requestors want that type of media. This type of information can be persistently stored by the system, and can be used to rate either one-time or reoccurring events as to the amount of interest these particular events are attracting. Other types of social feedback schemes, some or all of which may be persistent over time, may also be used. For example, potential event attendees who grant event media requests may receive positive feedback from requestors, which may be publically posted. Thus the potential event attendees may receive useful social currency as a result, as well as potentially useful social contacts for future beneficial interactions.

In addition to social currency, this feedback can have other practical users as well. For example, event organizers, wishing to at least informally preserve a record of a given event, may proactively contact various highly rated event attendees and invite them to cover additional events. Thus potential event attendees who participate frequently and productively with the system may find that as they require more social feedback and a higher community reputation.

Although the inventions' system and method can operate on a stand-alone basis, in other embodiments, at least some information may optionally shared with other online social networks such as Facebook, Twitter, and the like. This way, for example, the Facebook friends of a highly rated potential event attendee can, at least with permission, find out what events that the potential event attendee has attended and submitted media data for, and this in turn may provide a useful ground for further useful social interactions.

1. A method by which a requestor may request media data pertaining to an event, said event having an event name, an event time, an event spatial location, and at least one potential event attendee, said method comprising:
determining the event name, event time and event spatial location of said event;
posting said event name, event time and event spatial location of said event on an Internet server, along with a request for at least one type of media data from said event;
accessing said Internet server from a mobile computerized device carried by a potential event attendee who is within a predetermined time window and spatial location window proximate said event time and event spatial location of said event, and retrieving at least said event name and said request for at least one type of media data from said event;
wherein if said potential event attendee decides to attend said event and grant said request for at least one type of media data from said event, then obtaining said at least one type of media data from said event, and transmitting said at least one type of media data from said event to said requestor.

2. The method of claim 1, wherein said mobile computerized device comprises a handheld device with a display screen, processor, at least one wireless transceiver, at least a GPS receiver, at least one video camera, and at least one microphone.

3. The method of claim 1, wherein said computerized device is a smartphone.

4. The method of claim 1, wherein accessing said Internet server from said mobile computerized device carried by said potential event attendee who is within said predetermined time window and spatial location window proximate said event time and event spatial location of said event is done by, over a plurality of comparison times:
1: determining the spatial location of said potential event attendee;
2: transmitting said spatial location of said potential event attendee to said Internet server;
3: comparing said spatial location of said potential event attendee with the spatial location of said event;
wherein if said spatial location of said potential event attendee is within a predetermined spatial location window proximate said spatial location of said event, and said time of said comparison is within said predetermined time window proximate said time of said event, then transmitting at least said event name and said request for at least one type of media data from said event to said mobile computerized device carried by said potential event attendee.

5. The method of claim 4, wherein GPS data or Wireless signal origination point data from said computerized device is used to determine the spatial location of said potential event attendee.

6. The method of claim 1, wherein said media data comprises audio recordings of said event or video recordings of said event.

7. The method of claim 6, wherein said audio recordings of said event or video recordings of said event are made using said computerized device.

8. The method of claim 6, wherein transmitting said at least one type of media data from said event to said requestor is done by streaming or uploading said media data from said computerized device to said internet server, and said requestor then streams or downloads said media data from said internet server.

9. The method of claim 8, wherein a second requestor, who requests said media data either before or after said event, streams or downloads said media data from said internet server.

10. The method of claim 6, wherein transmitting said at least one type of media data from said event to said requestor is done by streaming or uploading said media data from said computerized device to said requestor.

11. The method of claim 1, wherein said retrieving at least said event name and said request for at least one type of media data from said event is done by either a push or pull process.

12. A method by which a requestor may request media data pertaining to an event, said event having an event name, an event time, an event spatial location, and at least one potential event attendee, said method comprising:
determining the event time and event spatial location of said event;
posting said event name, event time and event spatial location of said event on an Internet server, along with a request for at least one type of media data from said event;
accessing said Internet server from a mobile computerized device carried by a potential event attendee who is within a predetermined time window and spatial location window proximate said event time and event spatial location of said event by, over a plurality of comparison times, performing the steps of:
1: using GPS or wireless signal origination data from said mobile computerized device to determine the spatial location of said potential event attendee;
2: transmitting said spatial location of said potential event attendee to said Internet server;
3: comparing said spatial location of said potential event attendee with the spatial location of said event;
wherein if said spatial location of said potential event attendee is within a predetermined spatial location window proximate said spatial location of said event, and said time of said comparison is within said predetermined time window proximate said time of said event, then transmitting at least said event name and said request for at least one type of media data from said event to said mobile computerized device carried by said potential event attendee;
wherein said mobile computerized device comprises a handheld device with a display screen, processor, at least one wireless transceiver, at least one video camera, and at least one microphone;
wherein if said potential event attendee decides to attend said event and grant said request for at least one type of media data from said event, then obtaining at least one type of audio or video media data from said event using said mobile computerized device, and transmitting said at least one type of media data from said event to said requestor.

13. The method of claim 12, wherein transmitting said at least one type of media data from said event to said requestor is done by streaming or uploading said media data from said computerized device to said internet server, and said requestor then streams or downloads said media data from said internet server.

14. The method of claim 13, wherein a second requestor, who requests said media data either before or after said event, streams or downloads said media data from said internet server.

15. The method of claim 12, wherein transmitting said at least one type of media data from said event to said requestor is done by streaming or uploading said media data from said computerized device to said requestor.

16. The method of claim 12, wherein transmitting at least said event name and said request for at least one type of media data from said event to said mobile computerized device carried by said potential event attendee is done by either a push or pull process.

17. The method of claim 12, wherein said computerized device is a smartphone.

18. A method by which a requestor may request media data pertaining to an event, said event having an event name, an event time, an event spatial location, and at least one potential event attendee, said method comprising:
determining the event time and event spatial location of said event;
posting said event name, event time and event spatial location of said event on an Internet server, along with a request for at least one type of media data from said event;
accessing said Internet server from a mobile computerized device carried by a potential event attendee who is within a predetermined time window and spatial location window proximate said event time and event spatial location of said event by, over a plurality of comparison times, performing the steps of:
1: using GPS or wireless signal origination data from said mobile computerized device to determine the spatial location of said potential event attendee;
2: transmitting said spatial location of said potential event attendee to said Internet server;
3: comparing said spatial location of said potential event attendee with the spatial location of said event;
wherein if said spatial location of said potential event attendee is within a predetermined spatial location window proximate said spatial location of said event, and said time of said comparison is within said predetermined time window proximate said time of said event, then transmitting at least said event name and said request for at least one type of media data from said event to said mobile computerized device carried by said potential event attendee by either a push or pull process;
wherein said mobile computerized device comprises a handheld device with a display screen, processor, at least one wireless transceiver, at least one video camera, and at least one microphone;
wherein if said potential event attendee decides to attend said event and grant said request for at least one type of media data from said event, then obtaining at least one type of audio or video media data from said event using said mobile computerized device, and transmitting said at least one type of media data from said event to said requestor;
wherein transmitting said at least one type of media data from said event to said requestor is done by streaming or uploading said media data from said computerized device to said internet server, and said requestor then streams or downloads said media data from said internet server; or
wherein transmitting said at least one type of media data from said event to said requestor is done by streaming or uploading said media data from said computerized device to said requestor.

19. The method of claim 18, wherein said computerized device is a smartphone.

20. The method of claim 18, wherein more than one requestor requests media data pertaining to said event, and the number of said requestors is communicated to said potential event attendee.

21. The method of claim 18, wherein said requestor is notified when said at least one type of media data is transmitted by said at least potential event attendee.
